(19) United States
(12) Patent Application Publication
(10) Pub. No.: US 2007/0146551 A1
(43) Pub. Date: Jun. 28, 2007

(54) Multimedia receiver having fast predictive channel tuning and method

(75) Inventor: Kevin A. O'Neil, Toronto (CA)

Correspondence Address: SMART AND BIGGAR, 438 UNIVERSITY AVENUE, SUITE 1500 BOX 111, TORONTO, ON, M5G2K8, CA

(73) Assignee: ATI Technologies Inc.

(21) Appl. No.: 11/315,039

(22) Filed: Dec. 23, 2005

(51) Int. Cl. H04N 7/173; H04N 5/50; H04N 7/16

(52) U.S. Cl. 348/731; 725/100; 725/131; 725/139; 725/151

(57) ABSTRACT

A multimedia receiver includes two tuners capable of independently tuning digital channels to be listened to, or viewed. A channel to be tuned by a multi-media receiver is predicted, based on a subset of digits input by a user. While a current channel is tuned by one tuner, the predicted channel is tuned by the other tuner. If the prediction is correct, the channel to be turned is available for presentation immediately after a time out period. In this way, delay between tuning channels is reduced.

### FIELD OF THE INVENTION

The present invention relates to receivers, and more particularly to channel tuning by such receivers. The invention is particularly suitable for use in digital multimedia receivers, including televisions and set-top boxes.

### BACKGROUND OF THE INVENTION

The selection of media programs available to today's viewing and listening audience is vast when compared to the selection available one, two or three decades ago. Early conventional NTSC broadcast television for example, provided 12 channels on a VHF band. With the addition of a UHF band, the number of possible channels increased to about 83. Of course in most locations, available channels were sparsely used.

With the introduction of cable and satellite television, the number of channels increased, almost exponentially. Today, cable and satellite operators offer viewers hundreds of available channels, with channel numbers ranging from 0 to 999.

Often, viewer choice is accompanied by indecision. Accordingly, viewers tend to change channels often, and wish to change channels quickly. This is made possible by the use of remote controls.

In order to change the channel that is displayed, users will frequently employ a numerical keypad on a remote control in order to enter a desired channel number. Most remote controls work by having the user input each digit of the desired channel number. For example, if the user desires to enter a two digit channel such as “21”, the user will input a “2” into the remote control followed by a “1”.

In order to determine if the viewer has completed his or her channel selection, at least three techniques are employed. These include the use of an “enter” or similar key to signal completion of channel entry; the use of fixed length channel numbers (e.g. channel “1” is identified as channel “001”); and the use of a time-out period.

With digital television, there is a noticeable time delay between the completion of the entry of a channel number and the actual display of the selected video associated with the channel. This time delay results from the nature of digital content transmission and reception. Each digital channel that is selected must typically be tuned, demodulated, and decoded before the television signal is in a form suitable for display. Each of these processing steps takes time and adds to the time delay in displaying a digital channel.

These signal processing steps may account for a delay of approximately 0.5 to 0.7 seconds between when a tuner is first tuned to a digital television channel and the time when the video information is displayed. Most commonly, a receiver will display a black screen during this delay period. When combined with use of a time-out period, tuning delay can amount to a second or more. A similar delay exists for digital satellite radio, when a tuner is first tuned to a digital radio channel.

For many users this delay is simply intolerable, and detracts from fast and continuous channel changing, and television viewing or radio listening enjoyment.

Accordingly, there remains a need for improved methods of changing digital channels. In particular, there is a need to reduce the delay time that exists between the selection of a digital channel by a user and its eventual presentation on an output device.

### SUMMARY OF THE INVENTION

In accordance with the present invention, a channel to be tuned by a multi-media receiver is predicted, based on a subset of digits input by a user. While a current channel is tuned by one tuner, the predicted channel is tuned by another tuner. If the prediction is correct, the channel to be turned is available for presentation immediately after a time out period. In this way, delay between tuning channels is reduced.

In accordance with an aspect of the present invention, there is provided a method of operating a digital receiver, capable of concurrently tuning at least two digital channels, the method including while a first signal carried on a first channel is output by a first tuner, receiving inputs identifying sequential digits in an identifier of a second channel; and after receipt of each of the digits, and prior to receipt of an indicator that the identifier of the second channel has been completely provided, tuning a second tuner to a predicted channel defined by the sequential digits already received.

In accordance with another aspect of the present invention, a digital receiver for receiving a plurality of digital channels, includes a first tuner capable of tuning at least one digital channel; a second tuner capable of tuning, independently and concurrently with the first tuner, at least one digital channel; a selector configured to present either an output of the first tuner or an output of the second tuner for provision to an interconnected output device; and a controller, in communication with the first tuner, the second tuner, and the selector, the controller operable to, tune the first tuner to a first signal carried on a first channel and output the first signal; receive inputs identifying sequential digits in an identifier of a second channel, while the first signal is tuned by the first tuner; tune the second tuner to a predicted channel defined by sequential digits already received, after receipt of each of the digits and prior to receipt of an indicator that the identifier of the second channel has been completely provided; and control the selector to present a signal tuned by the second tuner to the interconnected output device, after a time-out period during which no further digit has been received.

In accordance with another aspect of the present invention, there is provided a computer readable medium storing processor executable instructions, the processor executable instructions adapting a programmable device in communication with a first tuner and a second tuner to tune the first tuner to a first signal carried on a first channel and output the first signal; receive inputs identifying sequential digits in an identifier of a second channel, while the first signal is tuned by the first tuner; tune the second tuner to a predicted channel defined by sequential digits already received, after receipt of each of the digits and prior to receipt of an indicator that the identifier of the second channel has been completely provided; and present a signal tuned by the second tuner to an interconnected output device, after the second channel has been completely provided.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a simplified block diagram showing a set-top box exemplary of an embodiment of the present invention; and

FIG. 2 is a flow chart, illustrating a process for reducing the delay associated with changing digital channels in accordance with an embodiment of the present invention.

### DETAILED DESCRIPTION

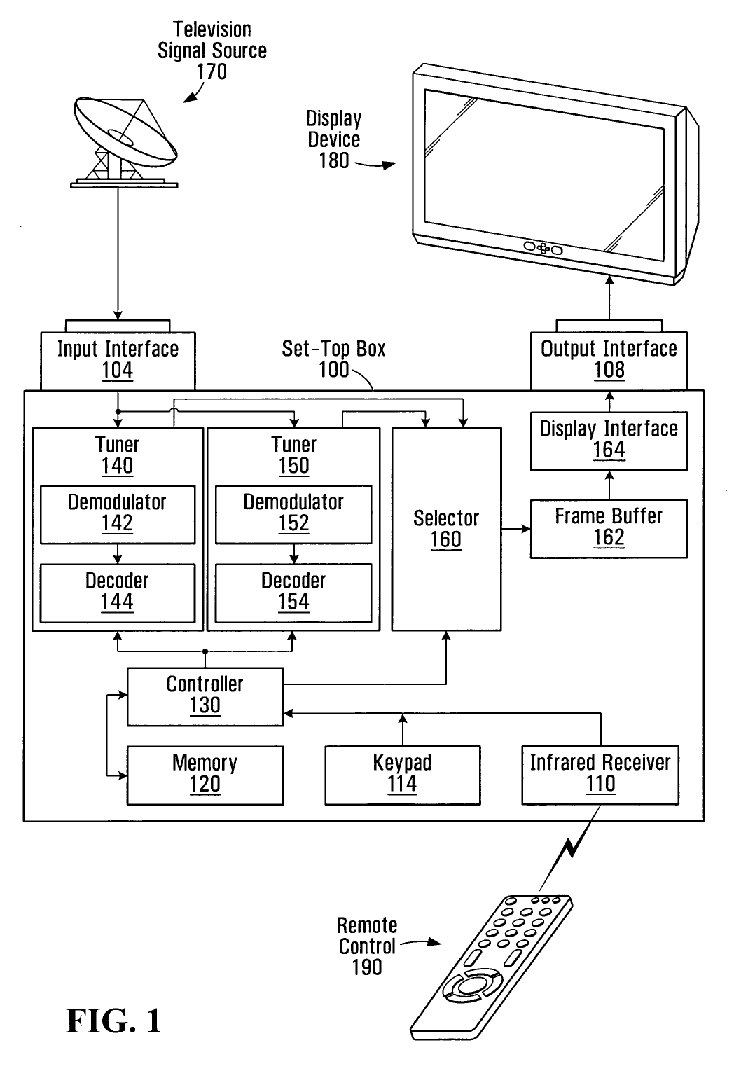

FIG. 1 is a simplified block diagram exemplary of a multimedia receiver, in the form of a set-top box 100, exemplary of an embodiment of the present invention. As will become apparent, set-top box 100 is adapted to reduce the delay time that exists between the selection of a digital channel by a user and its tuning and eventual display on a display 180, in the form of television, monitor, or other display.

As illustrated, set-top box 100 includes two tuners 140, 150 that may concurrently tune two different digital channels received from one or more signal sources, such as source 170. Set-top box 100 may be a receiver for receipt of cable, VDSL, satellite or broadcast television signals. Set-top box 100 may also function as a personal video recorder (PVR). Multiple tuners 140, 150 may be primarily used for presenting two signals simultaneously, as for example a picture-in-picture. The multiple tuners 140, 150 could similarly be used if box 100 further functions as a PVR, with one tuner presenting a channel currently viewed, and the other presenting a channel being recorded.

Tuneable signals may be received in many forms, including digital television or radio signals, received from satellite and terrestrial broadcasts, coaxial or fiber optic cables, or the like. Signals to be tuned may be provided to one or more interfaces of set-top box 100, including accompanying connectors, like interface 104 in the form of a radio-frequency interface with a coaxial connector. Other possible interfaces such as a VDSL interface, optical cable interface, terrestrial tuner, or similar will be apparent to those of ordinary skill.

Set-top box 100 further includes a user interface. In the depicted embodiment the user interface includes a receiver 110 for receiving signals from a wireless remote and a complementary remote control 190. Receiver 110 may, for example, be an infrared or radio frequency receiver. Set-top box may further include user controls, such as a keypad 114, mounted on the case of set-top box 100.

In the depicted embodiment, tuners 140 and 150 are digital tuners, suitable for tuning a channel containing a digital video signal, and decoding such a signal. Tuner 140 is thus a component in a digital signal processing pipeline that also includes demodulator 142 and decoder 144. Similarly, tuner 150 includes demodulator 152 and decoder 154. Outputs of either tuner 140 or tuner 150 provide a digital video signal to a frame buffer 162, by way of a selector 160. Selector 160 selects the digital output of either tuner 140, or 150 for output to a frame buffer 162 and display interface 164 for ultimate display on display device 180 via output port 108. Selector 160 may, for example, take the form of multiplexer/selector.

Set-top box 100 also includes a central controller 130. In the depicted embodiment, controller 130 takes the form of a processor, in communication with memory 120. Controller 130 may similarly take the form of custom logic forming a state machine, or the like. Controller 130 controls the overall functions of set-top box 100 and is in communication with infrared receiver 110, keypad 114, memory 120, selector 160, and tuners 140, 150.

In the depicted embodiment of FIG. 1, controller 130 operates under control of software stored within memory 120. The software may optionally be provided by way of computer readable medium (e.g. optical disk or the like) to upgrade existing set-top boxes.

In any event, the software may cause controller 130 to respond to user inputs received by the infrared receiver 110 or keypad 114. For example, the software executed by controller 130 may in response to the entry of a channel number into remote control 190, instruct tuner 140 or tuner 150 to tune to a digital channel identified by the user input channel number. Selector 160 may also be instructed by the controller 130 to select the digital channel that is tuned to by tuner 140 for output via output port 108 to display 180. Output port 108 may be in the form of DVI ports, composite video ports, YPbPr connectors or the like.

Demodulator 142 down-converts a digital signal identified by channel to a baseband signal. For example, in the case of a cable signal, demodulator 142 may demodulate a Quadrature Amplitude Modulation (QAM) signal. In the case of broadcast television, the demodulator 142 may demodulate terrestrial ATSC signals. Other types of demodulators will be apparent to one of ordinary skill.

A channel identifier provided by a user may be converted to a channel and stream number, major and minor channel number or other channel identifier understood by demodulator 142. Demodulator 142 demodulates a stream corresponding to the channel. The digital signal demodulated by demodulator 142 is provided to decoder 144. The video and audio data define an encoded stream contained that is demodulated and decoded. Known video audio coding methods include MPEG-1, 2 or 4, ITU 264. Again other coding techniques will be known to those of ordinary skill.

Once decoding is completed by decoder 144, the digital content is in a form that is ready to be rendered onto a display device 180. Typically, decoded video is stored in a frame buffer 162, and converted to a suitable analog format by video display interface 164.

Tuning (e.g. demodulating, decoding, and/or otherwise processing a data stream) of any particular channel by tuner 140 or 150, typically introduces a processing delay of between 0.5 to 0.7 seconds. Accordingly, tuning from one channel to another using a single tuner makes this delay perceptible to the user.

Furthermore, controller 130 must also determine whether the user has completed channel entry. To that end, controller 130 may respond to a time out period during which no further key input is received. A typical time-out period may be approximately 0.3 to 0.5 seconds each time a numerical key on a remote control is pressed. When the time-out period has elapsed, the user is deemed to have completed channel entry. Accordingly, when a time-out period is used, determining that a user has completed entry of a new channel number and presenting the corresponding video, can result in approximate total delay time of 0.8 to 1.2 seconds.

In manners exemplary of embodiments of the present invention, one of tuners 140,150 is predictively tuned to a channel before controller 130 has determined a time-out has elapsed. Specifically, one of the two tuners 140,150 (referred to as the active tuner) is used to tune the channel currently being viewed, while the other tuner 150,140 (referred to as the stand-by tuner) is used to tune a predicted channel, identified by digits of a new channel as pressed by the user, prior to the expiry of any time-out period, or prior to pressing the enter or similar key. By tuning to a predicted channel before new channel input is complete, the total delay time experienced by the user may be reduced in the event that the predicted channel ultimately is the selected channel. Controller 130 may control the operation of tuners 140,150 so that the roles of tuners 140 and 150 as active and stand-by tuners are reversed, if the channel tuned by the stand-by tuner is the newly tuned channel.

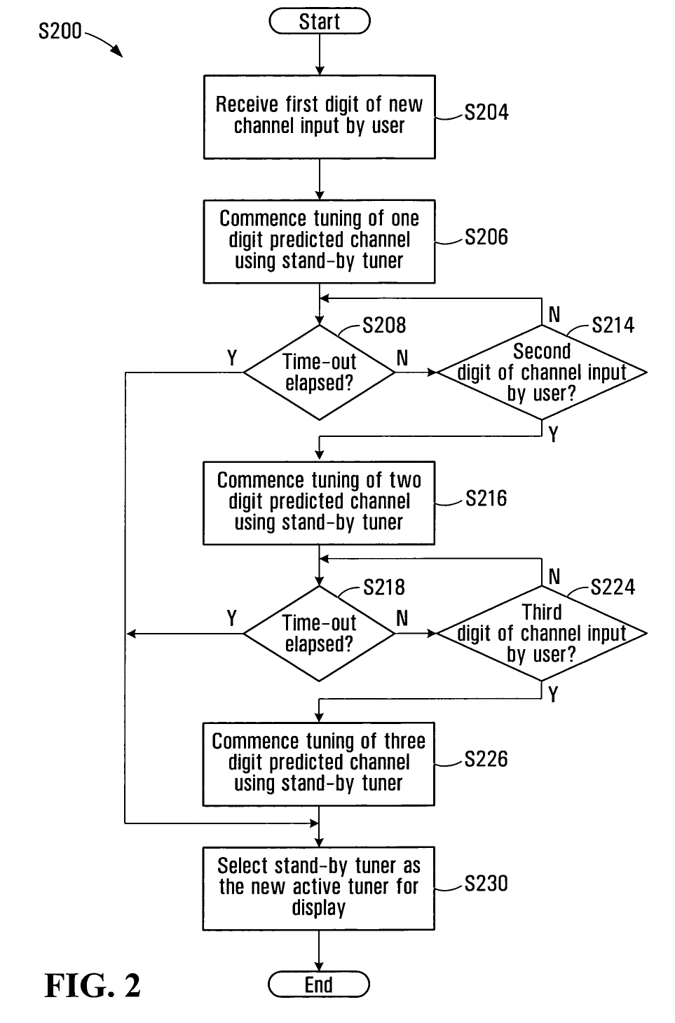

FIG. 2 is a flow chart illustrating exemplary steps S200 performed by set-top box 100 upon receipt of channel change input, while viewing an existing channel tuned by the active tuner. Steps S200 may be performed by controller 130 running a program in memory 120.

The stand-by tuner commences tuning to a new predicted channel each time the user inputs a new single digit of a desired channel number, while a channel tuned by the active tuner is presented on display 180. In step S204, the first digit of a new channel number is input by a user and received, for example, by receiver 110. Once the first digit of a new channel number is received in step S204, stand-by tuner, (e.g. tuner 150), is instructed by controller 130 to commence tuning to a one digit predicted channel defined by the first digit that was input in step S206.

For example, if tuner 140 is currently the active tuner and tuner 150 is the stand-by tuner, then if a user wishes to tune to channel number “2”, when the first digit “2” is received by infrared receiver 110, controller 130 instructs tuner 150 to commence tuning to a new predicted channel, in this case channel number “2”. Demodulator 152 and decoder 154 commence processing channel number “2” as well.

In step S208, controller 130 awaits expiry of a time-out period. If the time-out period expires, the stand-by tuner is selected as the new active tuner for display and the predicted channel becomes the new current channel in step S230. That is, if the time-out period elapses before the user enters a second digit, then it is determined that user input is complete, and controller 130 instructs channel selector 160 to select the channel tuned by tuner 150 for display, by selecting the output of decoder 154. Tuner 150 then becomes the active tuner and tuner 140 becomes the stand-by tuner. As tuner 150, including demodulator 152 and decoder 154 commenced processing of the predicted channel number (e.g. channel “2”) before the time-out has elapsed, the delay associated with the display of the new channel is reduced.

If, while awaiting a time-out period to expire in step S208, another digit of the new channel is input, as determined in step S214, controller 130 instructs the stand-by tuner to commence tuning to a two digit predicted channel, as defined by the two digits that have been input in step S216. Controller 130 commences re-tuning tuner 150 (the stand-by tuner) and tuner 150 commences tuning a newly predicted channel. In the example, if the user does not desire channel number “2” and actually wishes to view channel “23” or “23x” and the time-out has not elapsed before the second digit “3” is received by receiver 110, controller 130 instructs tuner 150 to commence tuning to the new predicted channel, in this case channel number “23”. Demodulator 152 and decoder 154 commence processing channel number “23” as well.

In step S218, if the time-out elapses before the user enters a third digit, then it is determined that user input is complete, and controller 130 instructs channel selector 160 to select the channel tuned by tuner 150 (i.e. channel number “23”) for display on display 180, by selecting the output of decoder 154. Tuner 150 then becomes the new active tuner and tuner 140 becomes the new stand-by tuner, in step S230. Since tuner 150, demodulator 152 and decoder 154 have already commenced processing of the predicted channel (e.g. channel “23”) before the time-out has elapsed, the delay associated with the display of the new channel is reduced.

If in step S218, another digit of the channel is received, as determined in step S224, the stand-by tuner is instructed by the controller 130 to commence tuning to the three digit channel defined by the three digits that have been input in step S226.

In this exemplary method, channel numbers may reach a maximum of three digits (i.e. 0-999) and thus, once a third digit has been entered by a user, it may be interpreted as completion of the entry of the new channel number, and in step S230 the stand-by tuner may be selected as the new active tuner for display and the predicted channel becomes the new current channel. Alternatively, the active tuner may be tuned immediately to the new channel upon receipt of the third digit.

Optionally, a fourth or subsequent digit may be entered by the user. This fourth digit may be treated as the new third digit of the predicted channel number, and the first digit received in step S204 may be discarded and processing may continue at step S226. Alternatively, the fourth digit may be treated as a new first digit of the predicted channel number, and processing may return to step S206. It is further contemplated that in other exemplary processes, the maximum number of digits in a channel number may be greater than three. It is also further contemplated that in other exemplary processes, some portion of the digits entered by a user may identify the major portion of a digital channel, while others may identify the minor portion of a digital channel.

Conveniently, both active and stand-by tuners need not be operating simultaneously for more than a short period of time (i.e. the period of time that the user is inputting the digits of a desired channel). Optionally, the stand-by tuner may be placed in a power saving mode. Typical power saving modes include, clock gating in order to reduce the clock frequencies of one or more ASICs (or one or more portions of an ASIC); voltage throttling in order to lower the supply voltage reaching one or more ASICs (or one of more portions of an ASIC); and resource hibernation in order place into a “sleep mode” or power down one or more ASICs (or one of more portions of an ASIC).

Embodiments of the present invention may also easily be combined with other known techniques for changing digital channels, including predictive techniques based on a user's “favourite” channels (as pre-defined by the user or through the maintenance of historical data ranking the channels that are most frequently used). For example, if a user enters the digit “2” followed by the digit “3”, and if it is known based on historical data that channel “23” is a channel that is never viewed by the user, a user's favourite three digit channel, such as “235” may be predictivly tuned to instead of “23”.

It will be appreciated that numerous types of electronic devices and computers have the capability of supporting the reception of digital channels, and accordingly, embodiments of the invention may be incorporated in a variety of receivers including set-top boxes, television receivers, personal computers, expansion cards and adapters, portable handheld devices (such as mobile telephones and PDAs), or the like.

It will be further appreciated that embodiments within the scope of the present invention include implementations in hardware, software or a combination thereof. For example, embodiments of the present invention also include computer readable media for storing processor instructions that may be loaded onto an electronic device in order to adapt the device to perform the stored processor instructions. Such stored processor instructions may be utilized in combination with special purpose hardware including special purpose computers, expansion cards and adapters, programmable electronic devices, or the like.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A method of operating a digital receiver, capable of concurrently tuning at least two digital channels, said method comprising:
while a first signal carried on a first channel is output by a first tuner, receiving inputs identifying sequential digits in an identifier of a second channel; and
after receipt of each of said digits, and prior to receipt of an indicator that said identifier of said second channel has been completely provided, tuning a second tuner to a predicted channel defined by said sequential digits already received.

2. The method of claim 1, further comprising
after a time-out period during which no further digit has been received, presenting a signal tuned by said second tuner on an output device.

3. The method of claim 1, wherein said indicator that said identifier of said second channel has been completely received, comprises receiving a third digit in said identifier of said second channel.

4. The method of claim 1, wherein said predicted channel is defined by the three most recent digits received.

5. The method of claim 1, further comprising providing outputs from said first and second tuners to a selector, and controlling said selector to present an output of said second tuner, after a time-out period.

6. The method of claim 1, further comprising placing one of said first and second tuner from which no tuned signal is presented in a stand-by power mode.

7. The method of claim 1, further comprising tuning one of said first and second tuner to said second channel, immediately upon receipt of said indicator that said identifier of said second channel has been completely received.

8. The method of claim 1, wherein each of said sequential digits is received by way of a user input device configured to receive inputs identifying said sequential digits.

9. The method of claim 8, wherein said user input device is a wireless remote control.

10. The method of claim 1, wherein said first and second tuner tunes one of terrestrial broadcast signals, satellite broadcast signals, or signals transmitted via twisted pair, coaxial or fiber optic cable.

11. The method of claim 1, wherein said receiver is one of a set-top box, television, personal video recorder, personal computer, expansion card or portable handheld device.

12. A digital receiver for receiving a plurality of digital channels, comprising:
a first tuner capable of tuning at least one digital channel;
a second tuner capable of tuning, independently and concurrently with said first tuner, at least one digital channel;
a selector configured to present either an output of said first tuner or an output of said second tuner for provision to an interconnected output device; and
a controller, in communication with said first tuner, said second tuner, and said selector, said controller operable to,
tune said first tuner to a first signal carried on a first channel and output said first signal;
receive inputs identifying sequential digits in an identifier of a second channel, while said first signal is tuned by said first tuner;
tune said second tuner to a predicted channel defined by sequential digits already received, after receipt of each of said digits and prior to receipt of an indicator that said identifier of said second channel has been completely provided; and
control said selector to present a signal tuned by said second tuner to said interconnected output device, after a time-out period during which no further digit has been received.

13. The receiver of claim 12, wherein said controller uses receipt of a third digit in said identifier of said second channel as said indicator that said identifier of said second channel has been completely received.

14. The receiver of claim 12, wherein said controller is operable to define said predicted channel by the three most recent digits received.

15. The receiver of claim 12, further comprising a user input device configured to receive inputs identifying said sequential digits.

16. The receiver of claim 12, further comprising a wireless remote control signal receiver, wherein each of said sequential digits is received by way of said wireless remote control signal receiver.

17. The receiver of claim 12, wherein said controller is further operable to place one of said first and second tuner from which no tuned signal is presented in a stand-by power mode.

18. The receiver of claim 12, wherein said controller is further operable to tune one of said first and second tuner to said second channel, immediately upon receipt of said indicator that said identifier of said second channel has been completely received.

19. The receiver of claim 12, wherein said controller comprises a processor and a processor readable memory.

20. The receiver of claim 12, wherein said first and second tuner tunes one of terrestrial broadcast signals, satellite broadcast signals, or signals transmitted via twisted pair, coaxial or fiber optic cable.

21. The receiver of claim 12, wherein said receiver is one of a set-top box, television, personal video recorder, personal computer, expansion card or portable handheld device.

22. A computer readable medium storing processor executable instructions, said processor executable instructions adapting a programmable device in communication with a first tuner and a second tuner to:
tune said first tuner to a first signal carried on a first channel and output said first signal;
receive inputs identifying sequential digits in an identifier of a second channel, while said first signal is tuned by said first tuner;
tune said second tuner to a predicted channel defined by sequential digits already received, after receipt of each of said digits and prior to receipt of an indicator that said identifier of said second channel has been completely provided; and
present a signal tuned by said second tuner to an interconnected output device, after said second channel has been completely provided.
